(19) United States
(12) Patent Application Publication
(10) Pub. No.: US 2013/0330831 A1
(43) Pub. Date: Dec. 12, 2013

(54) SYSTEM FOR WATER AND FOOD SAFETY TESTING

(71) Applicant: Gauge Scientific, Inc., Redwood City, CA (US)

(72) Inventors: Danny Morrow, Redwood City, CA (US); Andrew Hannum, Littleton, CO (US)

(21) Appl. No.: 13/849,407

(22) Filed: Mar. 22, 2013

Related U.S. Application Data
(60) Provisional application No. 61/614,431, filed on Mar. 22, 2012.

(51) Int. Cl. G01N 21/78

(52) U.S. Cl. CPC G01N 21/78
USPC 436/169

(57) ABSTRACT

A system for testing for environmental contaminants using strip tests, obtaining and uploading images of strip tests into a processor, associating a test data set including location, time, and date of test with each image, determining a test result through computational analysis of each image, and storing and reporting test results and data sets.

### CROSS-REFERENCE TO RELATED APPLICATIONS

This application claims the benefit of U.S. Provisional Patent Application No. 61/614,431, entitled “SYSTEM FOR WATER AND FOOD SAFETY TESTING” filed on Mar. 22, 2012, which is hereby incorporated by reference in its entirety for all purposes.

### BACKGROUND OF THE INVENTION

News reports about fertilizer, pesticides and pathogens in our streams, drinking water and food have become commonplace. Recently Congress passed the Food Safety Modernization Act. Water quality boards and government groups across America are passing laws to monitor water pollution from farm runoff. Beaches along the Atlantic and Pacific shores are often closed due to E coli contamination from faulty sewage treatment.

To determine how severe the problem is and how to react, data is needed on the severity of the pollution, location and time. First, an accurate measurement of the pollutant concentration in the environment needs to be made and compared to limits set by governing bodies. Most often, the location and time of a data point is also crucial.

We expect governmental entities such as the US Department of Agriculture and EPA to set safe limits, monitor, and enforce these limits. Historical methods of testing rely on environmental engineering contractors and labs using expensive capital equipment. Test programs take months to be completed and published. The USDA publishes data showing fresh produce is safe to eat while the Environmental Working Group publishes the “Dirty Dozen” list of contaminated produce each year.

Government budgets for testing have been reduced during the recession. People turn to the internet with questions about food and water pollution. A multimillion dollar industry has emerged to provide quick, inexpensive strip tests; sold to worried citizens. Hundreds of low-cost, simple tests are available to detect levels of arsenic, lead, nitrate, E. coli, etc. in the water and food. Most of these tests employ disposable test strips that change color based on the level of contaminant in the sample solution.

Single use disposable strip tests, which give a qualitative indication of analyte concentration based on color, have been commercially available for over 30 years. These strips change color when exposed to a target analyte and are then matched against a card containing a set of color squares with numbers indicating concentration of pollution. The user can determine the approximate level of analyte in the sample by holding the strip up against the card, identifying the color sample closest to the color of the exposed strip and writing down the number. Common strip tests measure pH in of water quality, chlorine in pools and spas, pesticides in drinking water; E coli in drinking water; etc. Strip tests usually include a plastic substrate; a porous layer, a calorimetric indicator impregnated in the porous layer and a Color Bar. Examples of disposable strip tests are found in U.S. Pat. Nos. 3,006,735 and 5,620,658. Technology from the medical diagnostic industry is also sold into this marketplace. LFIA (Lateral Flow Immunochromagraphic Assay) technology usually generates two color lines on a strip test. One line tells if the test is working; the second is an indicator of whether the analyte the test is meant to detect is above a threshold level. The most common example is the pregnancy test “sticks.” Companies also sell E coli tests in this format.

There is a pervasive sentiment that the risk to our health from industrial chemicals in our food and water is increasing each year. Warnings and assignment of blame fill our newspapers and blogs. Our farms and industries are our livelihood, committed to selling safe, quality products. Our water quality agencies, the FDA, USDA and EPA work to keep us safe. They struggle with pollution issues covering millions of square miles, hundreds of thousands of farms and millions of shipping containers. Citizens and cash strapped government agencies need reliable data to monitor and solve problems. Accurate, timely, mapped data is critical but is not available for farm runoff, E coli on beaches and pesticide on imported produce.

Low-cost strip tests could supply data quickly, but there are four primary problems limiting their value. First, these tests can only provide subjective “qualitative” results since each tester is required to match the exposed test strip's color to one of the color samples on the color card. Variable lighting conditions, color sensitivity and even visual acuity can affect testers' judgment. Level of training is also a problem. Further, the limited number of color samples provided on a color card defines the test's precision, i.e. how does one evaluate a light yellow test strip sample that falls between the lighter yellow color sample marked 0.2 mg/l or nearer to the darker yellow color sample marked 0.3 mg/l? As a result, most government agencies do not use these types of tests.

A second problem arises in storing the test for later validation and review. The color on most of the test strips fades quickly, thus cannot be reliably stored.

The third problem with strip tests is that the test is not associated with a time, date or place; or the person doing the test. Responsibility for the polluted water is often determined by the location of the measurement. The transient nature of pollution problems requires careful time based records. Should the test results be used to assign blame for a pollution problem, location, time, date and tester identification is needed.

The fourth problem is the need to do multiple tests at the same time over a large area. Surface water contamination can cover many miles of a river. Mercury contamination in a bay or ocean can cover hundreds of square miles of area. E coli problems on a beach near a sewer outfall can cover miles. Test location allows the mapping necessary to monitor and enforce pollution laws.

These problems limit the evidential value of strip tests to courts and governmental agencies. Citizen groups who use strip tests to lodge a complaint or request remediation of a pollution problem may find their efforts blocked by opponents who point out some of these four limitations. In a publicized example, parents sued their school district to remove lead-contaminated paint from their children's school but no action was taken when the school demonstrated how often the tests yielded false positive results from the colorimetric strip test they bought on the internet.

### BRIEF DESCRIPTION OF THE DRAWINGS

FIG. 1 is a front view of a Back Card and Test Strip in accordance with one embodiment of the invention.

FIG. 2 is a series of screen shots which illustrate a sequence of steps which can be employed in the user interface disclosed herein as one embodiment of the inventive system.

FIG. 3 is an example of a calibration curve which may be generated by one embodiment of the system described herein.

FIG. 4 is a diagram which illustrates the roles of a tester, a user, a mobile application, and a processor in accordance with one embodiment of the invention disclosed herein.

### DETAILED DESCRIPTION

Disclosed herein are methods, software, and devices which augment the use of colorimetric test strips to enable users to automatically analyze and record standardized test results and other data associated with a test event such as location and time.

Test strips, which have been validated and calibrated through iterative testing procedures, are used in this method. When a tester uses a test strip to perform a test, the test strip is placed against the Back Card and photographed following instructions in the software application on the smart phone The application then transmits the photograph to the online server via a broadband or WiFi connection to the phone. The application also transmits the GPS location of the test, time test taken and identification of the test phone. Computational image analysis software is then used to assign a value to that test result, and that value, the location, and the time and date of that test can then be wirelessly and automatically sent back to the smart phone where it originated from. Aggregate data can be presented using a web portal which will allow testers and users to view maps of data and share aggregated test data in the form of maps or reports.

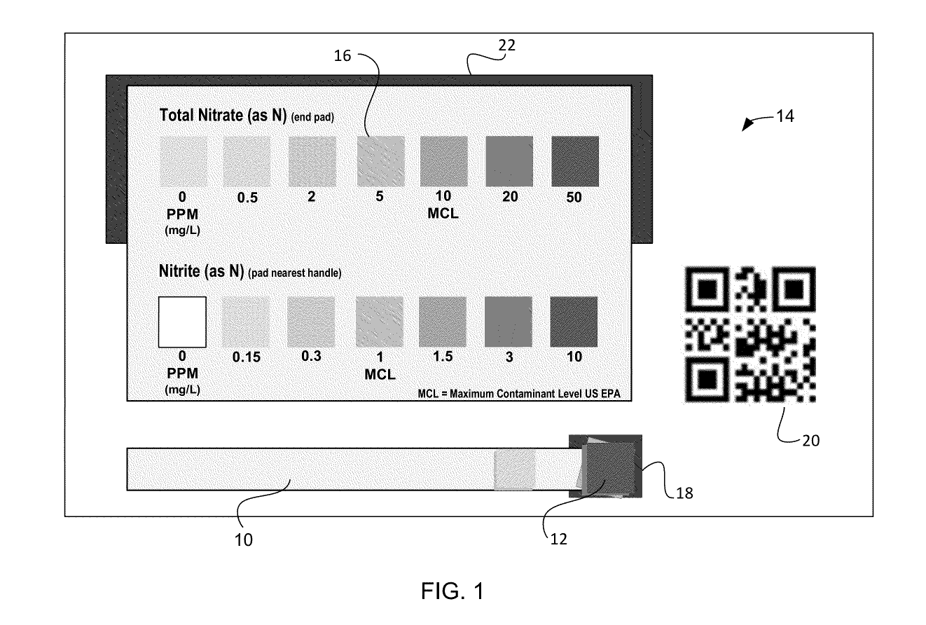

Referring to FIG. 1, Test strips 10 are typically elongated plastic strips with one or more absorbent, chemically treated pads 12 located near one end. At least one absorbent pad is chemically treated to change color to indicate the concentration of a contaminant when immersed in a test solution. An additional chemically treated pad may be present to determine whether testing protocols have been followed, for example whether the test strip has been immersed in the test solution for an appropriate amount of time. Commercially available colorimetric test strips can be used. For example, the WaterWorks Nitrate and Nitrite Part No. 480009 from Industrial Test Systems is appropriate for use in the inventive methods. However, any test strip used in this inventive method should be calibrated to yield reliable data when subjected to computational image analysis.

The Back Card 14 should be flat for ease of photography in the field using a smart phone. It should have a matte finish. It features a color bar 16, which is a graphic element printed on the Back Card consisting of a series of color squares which relate square color to contaminant concentration. Optionally present on the Back Card is a test square graphic 18, which can be a dark shape outlining the color bar, and which permits the inventive system to determine through computational image analysis whether the user has placed the test strip in the correct position. Optionally, bar codes 20 or other identifying information may be present on the back card so that test strip and Back Card identification information may also be processed digitally and aggregated along with test results, time, and location data. The inventive system may catalog individual test strips that are approved for use with the system, and may prevent use of an unauthorized test strip, re-use of a single test strip, or use of a single test in multiple locations by rejecting any such test data submitted.

The test strips are immersed into a sample of the test solution, for example the water that will be tested, in accordance with instructions which can be provided digitally over the web or with the test strips and/or back card. Once the test has been performed, the test strip is positioned against the back card, and the tester photographs the test strip and the back card.

A smart phone or other device with a processor and an operation system compatible with custom smart phone applications and capable of taking a photograph, and recording data such as time, date and location, can be used to photograph the test strip and the Back Card. An application that is either loaded onto the device or is operated by the device can guide the user's actions when performing the test, associate a data set with the image, and upload both for processing. For example, the application may provide information, including real time, step by step instructions for testing. The application may assist a tester in timing immersion of the test strip in the testing medium by providing alarms, a visual or auditory timer, or other signals. The application may also quantify the time which has elapsed between immersion or removal of the test strip in the testing medium and the photographing of the test strip and back card.

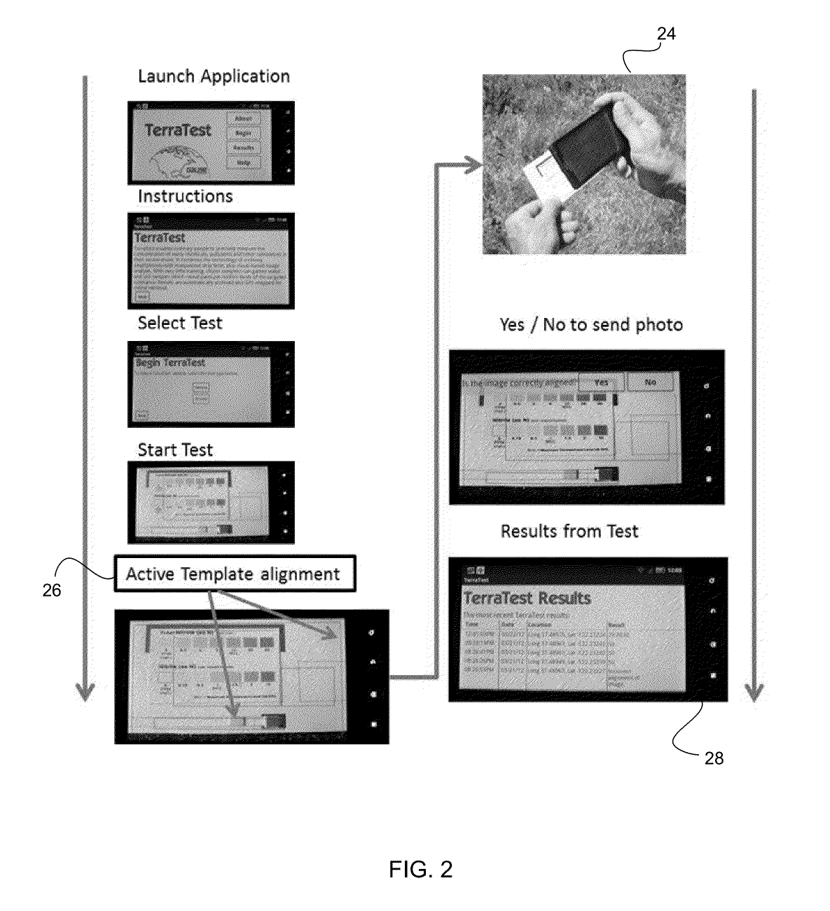

Referring to FIG. 2, the application will assist the User when taking a photograph with an active template or other digital alignment tool that corresponds to features on the back card or test strip, such as the color bar and test square on the back card. The user moves the phone into position 24, such that the graphic elements on the Back Card align with the Active Template. Alignment with the Active Template 26 assures the test results 28 are accurate.

Once a photograph is taken, the photograph is uploaded into the online system, where computational image analysis is used to derive a numerical value corresponding to the color present in the image of the absorbent pad on the test strip. The software performing this analysis can be calibrated and validated using the colors present in the color bar in the same photograph. This computational analysis, calibrated and verified, results in much more consistent, and less subjective, reading of the test strips. The device application also displays testing information such as the amount of time that elapsed between the beginning of the test and the photographing of the test strip, the time and date of the test, and the geographic location of the test. With or without additional user approval or input, the device level application then uploads that information along with the photograph to the system for analysis. In addition, the Application reviews the photograph for problems and alerts the User with with error messages, within the application, on the smart phone screen (e.g. low light, poor alignment, etc).

The test data and photograph are uploaded into a processor located on a server which is connected to the internet. The processor receives images and data and metadata from devices used in testing, and generates a data set from and associated with each photograph. The processor alerts device users of errors, and creates and stores verification if all testing protocols are observed by the user. The processor also operates or is used in conjunction with one or more databases, which store photographs, test results, test data, information about test kits, and errors, verification, and other information. The processor generates and stores a data set from each photograph. The processor aggregates test results and data, and can be used to provide reports which aggregate data into forms that provide for aggregate analysis such as maps showing the times and results of tests. The processor interfaces with a web portal which can work in conjunction with or instead of an application loaded onto a mobile device.

An application or web portal can be accessed using login data that identifies users with particularity. A web page associated with the processor may also sell test kits and other associated products. Information from testing may be available for download in aggregate form or from individual tests.

When the processor receives a photograph and associated data, it first performs a series of image analysis steps to locate the color bars and test square. Next, a computational script determines the luminance (candelas per square meter (cd/m2) for each square in the Color Bar and the Test Square. This data is linked to the sample identification number and stored on the processor. Software uses the digital data from the image analysis and applies mathematical image analysis algorithms to determine the test result.

In one embodiment, the processor determines the test result as follows. First the color bar data is used with stored data on test calibration to create a conversion function for each test. Next, the data for the luminance of the test square is related to the calibration curve to determine the initial test result. Then, mathematical algorithms are applied to improve accuracy and precision and determine the final test result. Next the test result is stored, linked to the sample identification, in the processor. Software reviews the location of the color bar on the color bar graphic 22, shown in FIG. 1, and the test square 12 on the test square graphic 18, and generates error messages if they are not present. The black square of the color card graphic is located and analyzed to determine if the color card is present. The black square of the test square graphic is located and analyzed to determine if the Test Strip 10 is present.

The optional single or two-dimension bar code 20 on the back card 14, if present, will be part of the photograph sent by the application, and contains data about the project and the identity of the test and the test strip kit OEM manufacturer.

A water quality agency which has received reports that there is high nitrogen concentration in a river, possible from fertilizer run off from farms along the river, can employ testers to use the inventive system and methods to determine the nitrate concentration at several locations along river. The testers could use one embodiment of the inventive system and methods as follows:

1) Login and create a project on the Web Portal.

2) Point and click on interactive map to designate sample sites along the river.

3) Select the Nitrate Test from the online list.

4) Follow online prompts to purchase the test

5) Receive Test Kits
a) Test Strips and Back Card and Printed Instructions
b) Clean sample collection bottle

6) Download test application and load onto smart phone

7) Print out project specific map

8) At each test location along the river:
a) Review Printed Instructions
b) Start Application
c) Collect sample in bottle
d) Dip Test Strip in bottle
e) Place Test Strip on Back Card
f) Follow instructions in application and obey prompts to complete the test and to capture an image
g) Approve image to send to the system. The application then sends the image to the system along with GPS location information, date, time, photo of the sample location, confirmation that the protocols were followed, etc.
h) Review Results. If Error, capture an additional image.

9) User access Web Portal on a PC to generate test reports and share data.

Additionally, in other embodiments, the processor may compare the color bar data from each image sent to processor to stored color card image data to determine if incident light on back card during tests was below optimum and generate an error message to transmit to smart phone. It may also compare the Color Bar data from each image sent to Processor to stored Color Card image data to determine if the Color Bar is out of focus and generate an error message and transmit to smart phone.

In other embodiments, the system may also error check image acceptance on smart phone when connection to the System is not available by utilizing software that reviews the location of the Color Bar on the Color Bar Graphic and the Test Square on the Test Square Graphic utilizing image analysis software resident in the application on the smart phone. The processor may also error check image acceptance on smart phone when connection to the processor is not available by adding additional graphic elements to the printed Back Card that can be analyzed on image analysis software resident in the Application on the smart phone.

The system may protect against counterfeit Back Cards by printing unique graphic elements on approved back cards that are recognized by image analysis software resident in the application on the smart phone.

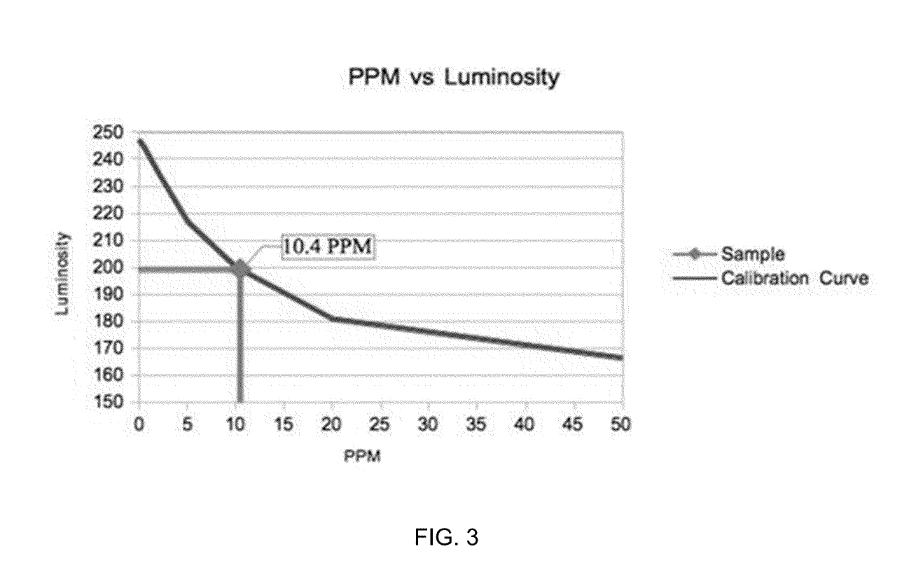

Additionally, the system may be operated to create improved calibration algorithms utilizing data from laboratory testing. This can be done by creating stock solutions with varying known concentrations of target compound across the range covered by Strip Test, then testing the stock solution using test strips and using the application to upload pictures of those test strips and Back Cards. The accuracy of the calibration curve, an example of which is shown in FIG. 3, which is used in the computational image analysis process can then be improved using the test results from the stock solutions. Calibration test data can be incorporated into the bar code on the back card and can form part of the data file associated with each test image.

Additional variations include the following. EPA maximum limits for a test compound can be added to test strips in order to show results at least in part as pass/fail. The Back Cards can be incorporated into test strip packaging. The application can prompt a user to take multiple pictures of a test strip at given time intervals in order to improve accuracy. Multiple test strips can be photographed in a single image.

The web portal can include training and certification procedures, and the completion of training and certification can be associated with a given use identifier and can be certified or recorded. The system can also capture user specific data such as the number of tests performed, aggregate test results, and the number of errors associated with that user's activity.

The test may include the imaging of a bar code or other identifier placed on a water bottle sample. The system would thereby record data regarding where and when the water sample was collected and the test results when the sample was collected.

Finally, the application may respond to a test performed where no GPS or data transfer is available by storing the image and data for upload later.

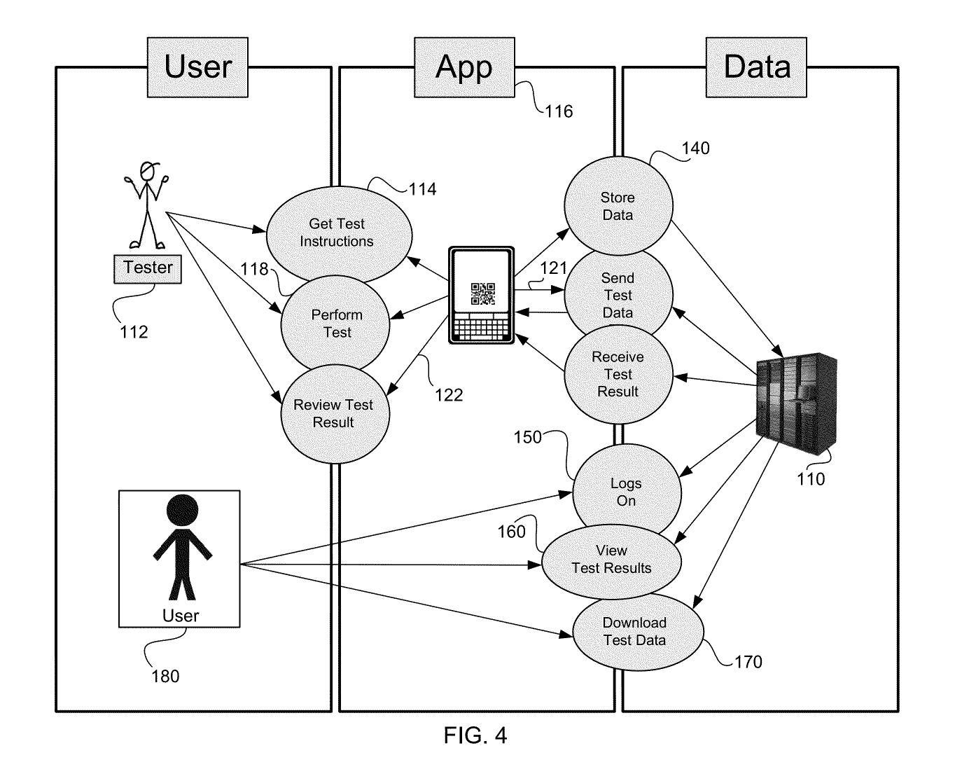

One embodiment of the system disclosed herein is illustrated in FIG. 4. A tester 112 gets test instructions 114 from a mobile device application 116. The tester uses those instructions to perform a test 118 and photograph 120 the test results. The mobile device 130 sends test data 121 to the system, which then processes it and sends results back to the mobile device for review 122 by the Tester. The results and data are stored 140 on the server 110, and a User 180 can log on 150 to the server, view test results 160, and download data 170.

The terms and expressions which have been used in this specification are intended to describe the invention, not limit it. The scope of the invention is defined and limited only by the following claims.

What is claimed is:

1. A method of generating a test result which measures the presence of a contaminant in a test solution, comprising:
a) immersing a strip test in said test solution, said strip test having an absorbent pad which is chemically treated to change color to indicate concentration of a contaminant;
b) removing said test strip from said test solution and generating a digital image of said test strip;
c) generating a test data set and associated said test data set with said image;
d) uploading said image and said test data to a first processer; and
e) using software present on said central processor to generate a test result using computational analysis of said image.

2. The method of claim 1 further comprising the step of transmitting said test result to a second processer in a location remote from said first processer.

3. The method of claim 1 wherein said test data comprises the time said image was generated and the location of a device used to generate said image.

4. The method of claim 1 wherein said processor evaluates placement of said strip test within said image and generates and transmits an error message if said placement does not comply with predetermined parameters.

5. The method of claim 2 wherein said image is generated by said second processor, and said second processer is wirelessly interconnected with said first processor, and said second processor generates data associated with said image.

6. The method of claim 1 wherein said first processor is adapted to aggregate multiple test results into one or more reports based on one or more commonalities within test data sets.

7. The method of claim 1 further comprising the step of aligning a test square graphic located on a back card with a digital alignment tool before said image is created.
